(19) United States
(12) Patent Application Publication
(10) Pub. No.: US 2011/0148636 A1
(43) Pub. Date: Jun. 23, 2011

(54) DETECTION SYSTEM

(75) Inventor: Casey L. Carlson, Edina, MN (US)

(73) Assignee: 3M Innovative Properties Company

(21) Appl. No.: 12/640,554

(22) Filed: Dec. 17, 2009

(51) Int. Cl. G08B 13/14

(52) U.S. Cl. 340/572.1

(57) ABSTRACT

A detection system, which detects items present within a radio frequency field generated by the detection system. The detection system may be used at the exits of a facility and assists in detection of items leaving the facility.

### TECHNICAL FIELD

The present invention relates to a detection system, which detects items present within a radio frequency field generated by the detection system. The detection system may be used at the exits of a facility and assists in detection of items leaving the facility.

### BACKGROUND OF THE INVENTION

Various types of electronic detection systems have become commonplace in libraries, retail stores and other locations. Such detection systems typically include one or more antennas that create a radio frequency field, which, along with the detection system's associated electronics, generates an interrogation zone. The presence of an object in the interrogation zone results in a response in the antenna, thereby allowing detection of the object.

Typically, the antenna is arranged in a lattice or wrapped around a panel that is rigidly affixed to the floor. Because electronic gate detection systems are typically installed such that users pass-by in close proximity, the lattice or panels must be robust enough to handle repeated impact over the life of the detection system. Further, the lattice or panels must protect the functionality of the antenna and other internal electronics.

Current gate detection systems address the issue of durability by providing lattices and panels that are both rigid and heavy to protect the antennas and electronics housed within. In addition, current gate detection systems often present functional limitations in the form of large shipping expenses, installation or maintenance difficulties. Further, the rigid structure and appearance encourages rough treatment such as climbing by children who visit libraries where such detection systems are installed.

Various detection systems are known. For example, U.S. Pat. No. 6,061,552 discloses a pedestal assembly for an electronic article surveillance system comprising an antenna, an electronic assembly, and a support member having at least first and second recesses. The antenna is seated in the first recess and the electronic assembly is seated in the second recess. The antenna and electronic assembly are enclosed and accessible by unsecuring covers from the support member.

U.S. Pat. No. 4,994,939 discloses a universal lattice assembly for use in a magnetic type electronic article surveillance system that comprises a frame formed of two identical molded plastic half-shells, a metal chassis and a coil assembly. Upon insertion of the coil assembly and chassis with the half-shells, the two are permanently pinned and bonded together to form an exceptionally rigid and durable composite lattice.

### SUMMARY OF THE INVENTION

One aspect of the present invention provides a detection system. In one embodiment, the detection system comprises: a support structure, comprising a base and a support arm attached to the base; and a first antenna portion removably engaged with the support arm, wherein the first antenna portion is configured to form a radio frequency field for detecting items within the field, and wherein the support structure is rigid, and the antenna portion is flexible relative to the support structure.

Another aspect of the present invention provides another embodiment of a detection system. In this embodiment, the detection system comprises: a support structure, comprising an base and a support arm attached to the base; and a first antenna portion removably engaged with the support arm, wherein the first antenna portion is configured to form a radio frequency field for detecting items within the field, and wherein the first antenna loop portion includes shaping support members and an antenna wire wrapped under tension around the shaping support members.

Another aspect of the present invention provides yet another embodiment of a detection system. In this embodiment, the detection system comprises: a support structure, comprising a base and a support arm attached to the base; and a first antenna portion removably engaged with the support arm, wherein the first antenna portion is configured to form a radio frequency field for detecting items within the field, and wherein the first antenna loop portion includes a fabric portion and an antenna wire stretched around the fabric portion.

Another aspect of the present invention provides yet another embodiment of a detection system. In this embodiment, the detection system comprises: a support structure, comprising a base, and at least two vertical support arms extending from the base; and

a first antenna loop stretched between the two support arms, wherein the first antenna portion is configured to form a radio frequency field for detecting items within the field.

The above summary of the present invention is not intended to describe each disclosed embodiment or every implementation of the present invention. The Figures and the detail description, which follow, more particularly exemplify illustrative embodiments.

### BRIEF DESCRIPTION OF THE DRAWINGS

The present invention will be further explained with reference to the appended Figures, wherein like structure is referred to by like numerals throughout the several views, and wherein:

FIG. 1 is a perspective view of a prior art gate detection system located at an exit of a facility;

FIG. 2 is a side view of a first exemplary embodiment of the gate detection system of the present invention;

FIG. 3 is a perspective view of the main parts of the gate detection system of FIG. 2 unassembled and ready for shipping;

FIG. 4 illustrates a side view of a second exemplary embodiment of the gate detection system of the present invention;

FIG. 5 illustrates an exploded perspective view of the gate detection system of FIG. 4;

FIG. 6A illustrates a side view of a third exemplary embodiment of the gate detection system of the present invention;

FIG. 6B illustrates a perspective view of one of the shaping support members of the gate detection system of FIG. 6A;

FIG. 6C illustrates a side view of a portion of the gate detection system of FIG. 6A with a cover removed;

FIG. 7 illustrates a side view of a fourth exemplary embodiment of the gate detection system of the present invention;

FIG. 7A is a magnified view of one embodiment of a shaping support member of the gate detection system of FIG. 7;

FIG. 8 is a perspective view of a fifth exemplary embodiment of the gate detection system of the present invention;

FIG. 9 is a perspective view of the gate detection system of FIG. 8 oscillating back and forth; and

FIG. 10 is a perspective view of the gate detection system of FIG. 2 in a library setting.

### DETAILED DESCRIPTION OF THE INVENTION

Various detection systems are often found at exits of secured facilities, such as retail stores and libraries. One type of detection system is an electronic article surveillance (“EAS”) system, which, in one embodiment, includes the use of a marker formed of a strip of permalloy to be concealed within the spine of a book or adhered between the pages. These EAS systems use radio frequency waves to detect items within the fields they create. Another type of detection system is a radio frequency identification (“RFID”) system, which includes a marker including a radio frequency identification tag having an integrated circuit and an antenna, which is also located within the book. In some embodiments, these RFID systems may use high radio frequency energy, for instance in the range of 3 to 30 MHz, or ultra high radio frequency, for instance in the range of 300 to 3000 MHz to detect items within the field they create.

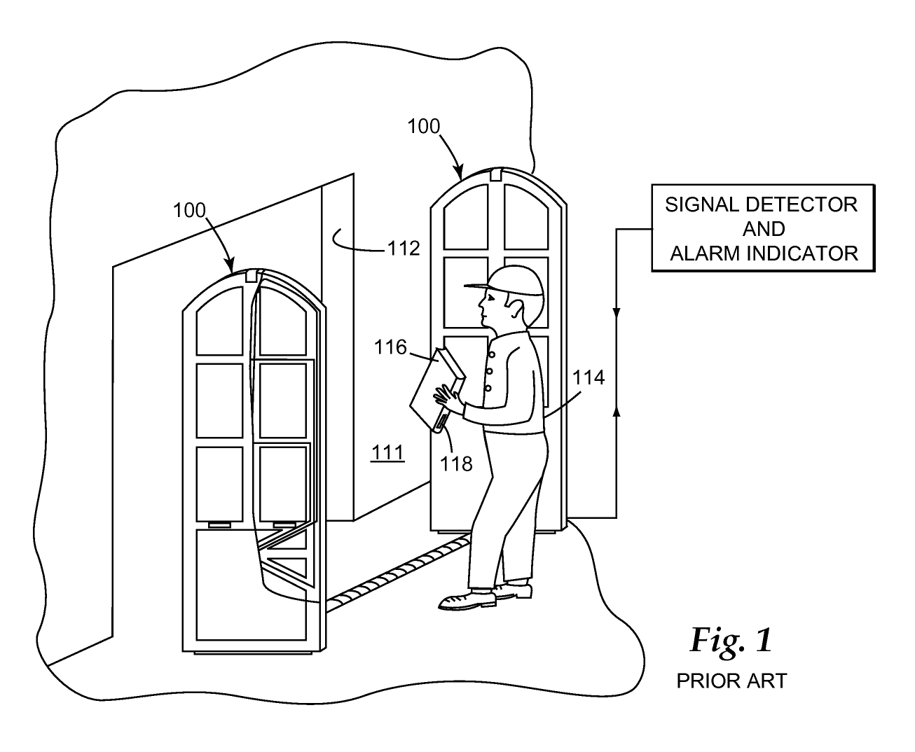

In one type of prior art EAS or RFID detection system illustrated in FIG. 1, a panel or lattice 100 is positioned adjacent an exit 112 of a secured facility. While such an installation may include a single lattice 100, most often such an installation will include a second lattice 100A, which is positioned parallel to and spaced apart from the first lattice 100, so as to define an interrogation zone 111 there between. In such a typical use, an object 116 to which a marker 118 is attached is carried by a customer, patron, etc. through an interrogation zone. The object 116 will be detected while in the interrogation zone, as follows. The marker 118 will interact with the radio frequency field generated by the antennas within the lattices 100, 100A. This will in turn cause a signal to be detected by the signal detector and trigger an alarm indicator. One suitable alarm may be provided by a flashing light or buzzer mounted on top of one or the other of the lattices 100, 100A.

These type of prior art gates illustrated in FIG. 1 or similar prior art gates are typically made of thick, heavy rigid forms with the antenna wire wrapped in its interior. One example of such a prior art gate illustrated in FIG. 1 is commercially available from 3M Company based in St. Paul, Minn. as part of the 3M™ Detection System, model 3800. These rigid gates typically have a high center of gravity requiring a secure floor anchor to resist the gate from falling over. For example, the gates may be mounted on a base plate or mounted directly to the floor. The heavy gates are typically shipped fully assembled, and weigh in the range of 88 pounds (44 kg) to 260 pounds (118 kg). Due to the structure, i.e. the physical size of the assembled gates and the weight of the gates, the associated shipping costs are fairly high.

Some prior art gates have portions with openings built in, to allow a user to see through portions of the gates. Some examples of such a gate are included in the 3M™ Detection Systems, model 2300, model 3500, model 3800, model 8800, and model 8900, all commercially available from 3M Company based in St. Paul, Minn. However, the structure of these types of gates is typically in the form of a lattice, making it appear similar to a ladder, or having the appearance of footholds, making the gates often attractive for children to climb on. Lastly, the structure of these gates may limit visibility and be obtrusive at the exits of the facility.

There is a need for a more modern and stylish detection system for detecting items leaving secured facilities. The detection system of the present invention provides various embodiments that are contemporary, high tech, and provide a fresh new look for detection systems. In addition, the detection system gates of the present invention are light-weight and easily assembled and unassembled, enabling such gates to be shipped in an unassembled state, thereby providing reduced shipping costs, compared to prior art systems. In some embodiments, the detection system gate breaks apart for compact shipping and is quickly assembled on-site similar to the frames of light-weight backpacking tents. In addition, the detection system gate support structure has elastic or flexible portions, which, in fact, bend when patrons bump into them by accident. If a child were to try to climb a gate of the detection system of the present invention, it distorts to a degree, so that it does not encourage their continued climbing. Due to the openness of the antenna portions of the gates of the detection system of the present invention, a more airy and light feel is created to what is normally a very heavy and rigid structure affiliated with prior art detection gates. The openness of the antenna portions also provides more visibility through the structure, making them less obtrusive compared to prior art detection systems.

Although the present specification includes various exemplary embodiments of the detection system of the present invention, those skilled in the art may make many changes in those embodiments without departing from the scope of the invention. For example, the gates of the detection systems of the present invention may be part of either an EAS or RFID detection system. One example of an EAS-enabled version of a detection system, including its associated electronics, is disclosed in U.S. Pat. No. 5,440,296, “Coil Assembly for Electronic Article Surveillance System,” (Nelson), which is hereby incorporated by reference. One example of an EAS-enabled version of a detection system, including it associated electronics, is commercially available from 3M Company located in St. Paul, Minn. as Library Detection System, model number 500. One example of an RFID-enabled version of the detection systems, including its associated electronics, is commercially available from 3M Company in St. Paul, Minn. as Library Detection System, model number 8900.

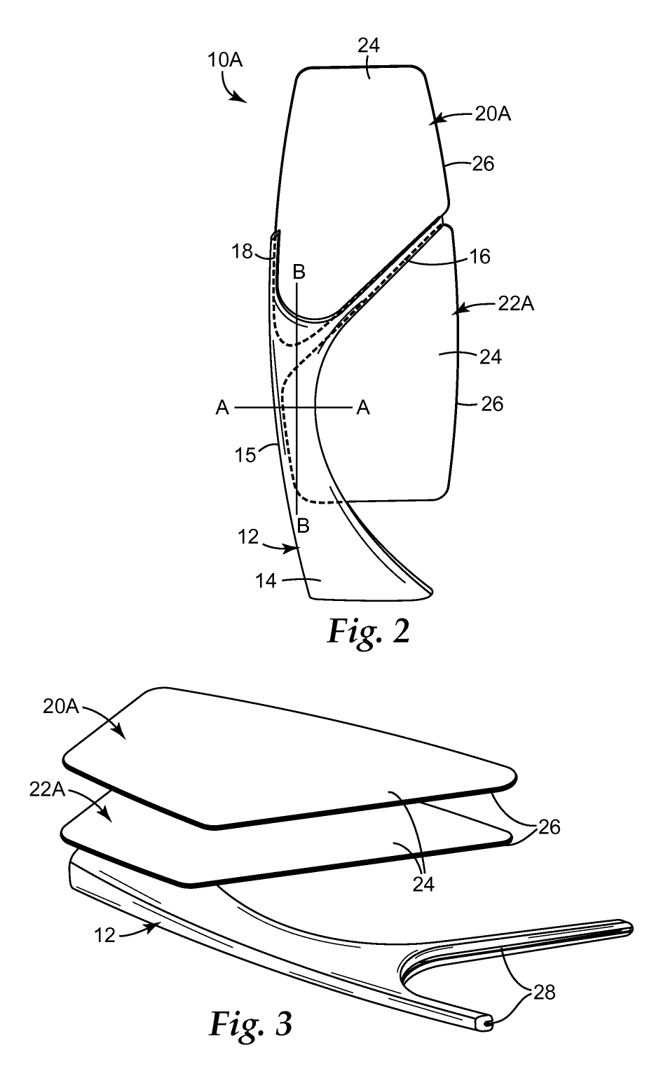

FIG. 2 illustrates a first exemplary embodiment of the gate detection system 10A of the present invention, as assembled. FIG. 3 illustrates the main parts of the gate detection system 10A unassembled. The gate detection system 10A includes a support structure 12 and at least one antenna portion 20. As illustrated, the gate detection system 10A includes base 14 and a support arm portion 15 extending from the base 14. The support arm portion 15 includes a first arm 16 and a second arm 18 extending from the support arm portion 15. The gate detection system 10A includes a first antenna portion 20A and a second antenna portion 22A. In this embodiment, the antenna portions 20A, 22A may be permanently engaged or removably engaged with the support structure 12. Preferably, the antenna portions 20 are removably engaged to allow the gate detection system 10 to be easily shipped and assembled on site, or unassembled and moved to a different location. By removeably engaged, it is meant that the antenna portions 20 may be easily separated or removed from the support structure 12, particularly to facilitate the disassembly or assembly of the gate detection system, as illustrated in FIG. 3. By permanently engaged, it is meant the antenna portions 20 may not be easily separated from the support structure 12 after it is assembled, and thus are considered permanently attached. The first antenna portion 20A is preferably removably engaged with the first arm 16 and the second arm 18. The second antenna portion 20B is preferably removably engaged with the first arm 16 and the support arm portion 15. Both antenna portions 20 may removeably engage with the support structure 12 by various techniques known to those skilled in the art. In the illustrated embodiment, the antenna portions 20 slideably engage with a slot 28 molded inside the arms 16, 18 and support arm portion 15. However, the antenna portions 20 may removably engage with the support structure 12 by bolts, screws, or friction snap fits.

In the illustrated embodiment, the antenna portions 20A, 22A includes a flat panel portion 24 with an antenna 26 wrapped around the exterior of the panel portion 24. In one embodiment, the panel portion 24 may be made of clear acrylic, allowing a user to see through the panel. One preferred arrangement of the antenna 26 is composed of 12 or 14-guage wire that is readily commercially available. The panel portion 24 and antenna 26 are constructed in an approximately trapezoidal shape. In the illustrated embodiment, the antenna portions 20A, 22A are approximately duplicate images of each other (as illustrated in FIG. 3) and when assembled, the antenna portions 20A, 22A are juxtaposed in substantially a coplanar orientation.

The detection gate system 10A is preferably asymmetrical in design relative to the horizontal plane (A-A), as illustrated in FIG. 2. The horizontal plane A-A is positioned along the side of the gate 10 that a user passes by when exiting a facility. In sharp contrast to prior art detection gate systems, this asymmetrical design gives the gate detection system a more modern look and feel. The base 14 is asymmetrical in shape about the structure's horizontal plane (A-A). The support arm portion 15 extends from the base 14 in a graceful arc-like shape, with the first support arm 16 extending there from, continuing along the same arc. The second support arm 18 extends upwardly from the support arm portion 15. Preferably, in another embodiment, the support structure 12 is asymmetrically shaped relative to the structure's vertical plane B-B. The vertical plane B-B is also positioned along the side of the gate 10 that a user passes by when exiting a facility. Preferably, the antenna portions 20 themselves are also asymmetrical. In another embodiment, the first arm 16, and the foot of the base both extend from one side of the support arm portion 15, away from the vertical plane B-B.

FIG. 3 illustrates the unassembled parts of the gate detection system 10A, which is ready for shipping. As illustrated, the unassembled parts may be packed into a relatively flat, rectangular box. The structure 12, and antenna portions 20A, 22A are conveniently sized to nest together well and thus, fit in a smaller box, which helps reduce shipping costs due to the reduced volume.

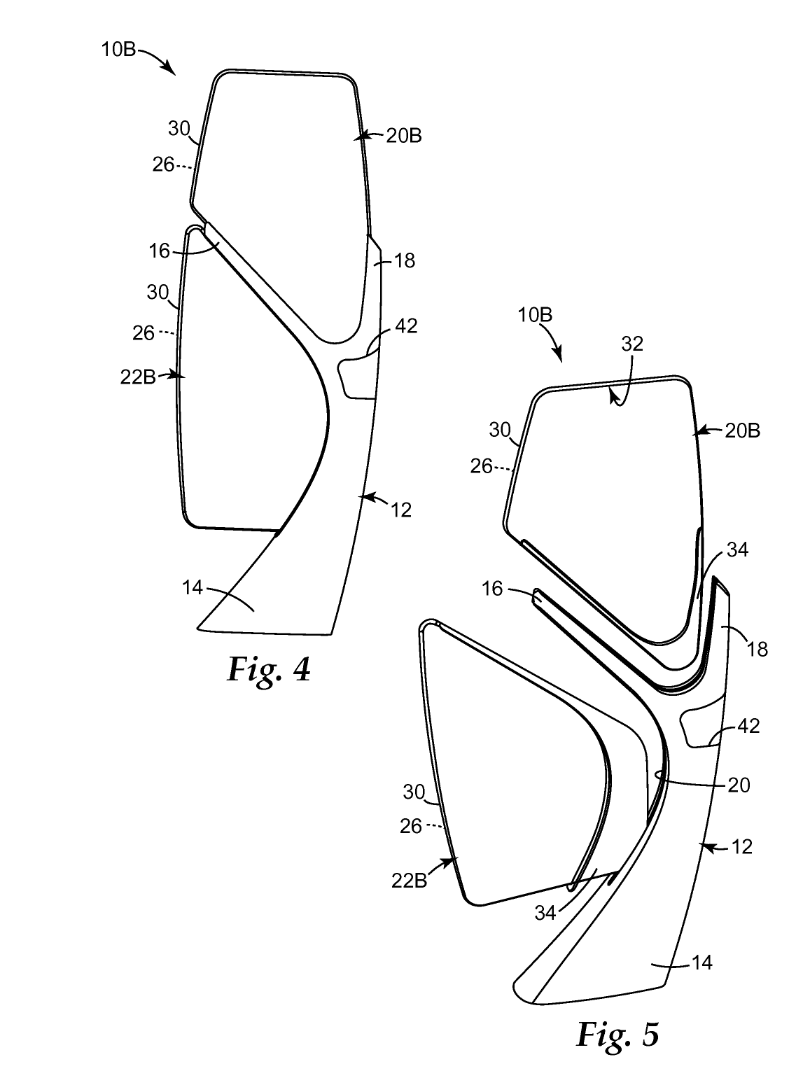

FIG. 4 illustrates a second exemplary embodiment of the gate detection system of the present invention. FIG. 5 illustrates an exploded view of the gate detection system 10B of FIG. 4. In this embodiment, the support structure 12 of the gate detection system 10B is preferably the same support structure 12 of the gate detection system 10A of FIG. 2 and may be either an EAS or an RFID gate detection system, except that the slot 28 is configured for receiving the flanges 34 of the antenna portions 20, 22. Antenna portions 20B, 22B include a flexible tube 30 with an antenna 26 strung through the tube 30. Preferably, flexible tube 30 is made from fiberglass or plastic and preferably has an inner diameter in the range of 0.080 inches (2.032 cms) to 0.180 inches (0.4572 cm.), and more preferably has an inner diameter of 0.120 inches (0.305 cm.). Preferably, the antenna 26 is made from commercially available 12 or 14-guage copper wire.

In the exemplary embodiment illustrated in FIGS. 4 and 5, the antenna portions 20B, 22B of the gate detection system 10B include a flange 34 and a plastic tube 30 with the antenna 26 strung through the tube 30. Preferably, the antenna 26 is a wire within the core of a continuous fiberglass or plastic tube. The flange 34 is configured to removeably engage the antenna portion 20B, 22B with the support structure via the slot 28 for a snap fit. For example, the flanges may include quick disconnects. The molded flange 34 seals the slot 28 when engaged with the slot 28. The flange 34 also provides additional support to the antenna portion 20 to allow the tube 30 to absorb impact, and to flex back and forth when bumped. An access door 42 may be included to allow on site assembly or servicing, or to allow a user to access a portion of the detection system's electronics.

The antenna portions 20B, 22B are flexible, especially relative to the rigid support structure 12. By “flexible,” as used herein including the claims, it is meant that the portion is capable of returning to its original shape and/or length after being stretched, deformed, compressed, expanded or bumped. The tube 30 may act similarly to a down-hill racing ski gate, where if it is bumped into, it flexes on impact, and then snaps back in place to its original position. For example, the fiberglass or plastic tube 30 may be capable of deflecting up to half of its length without breaking. For example, the antenna portions may include flexibility measurements of a shear modulus of 15 to 45 GPa. The antenna portion 20 may be moveable relative to the support structure 12. By moveable, it is meant its outer portions extending away from the rigid structure 12 can flex relative to the structure 12. In addition, the antenna portions 20 are light-weight. Preferably, the support structure 12 is rigid. In other words, it is not flexible or pliant or elastic. The support structure 12 may be made of polystyrene, for example.

The antenna portions 20 each include an opening 32 created by the shape of the flexible tube 30. This creates an airy feel to the gate detection system 10B, and allows a user to see through the gate detection system, making it less obtrusive, compared to prior art gate detection systems.

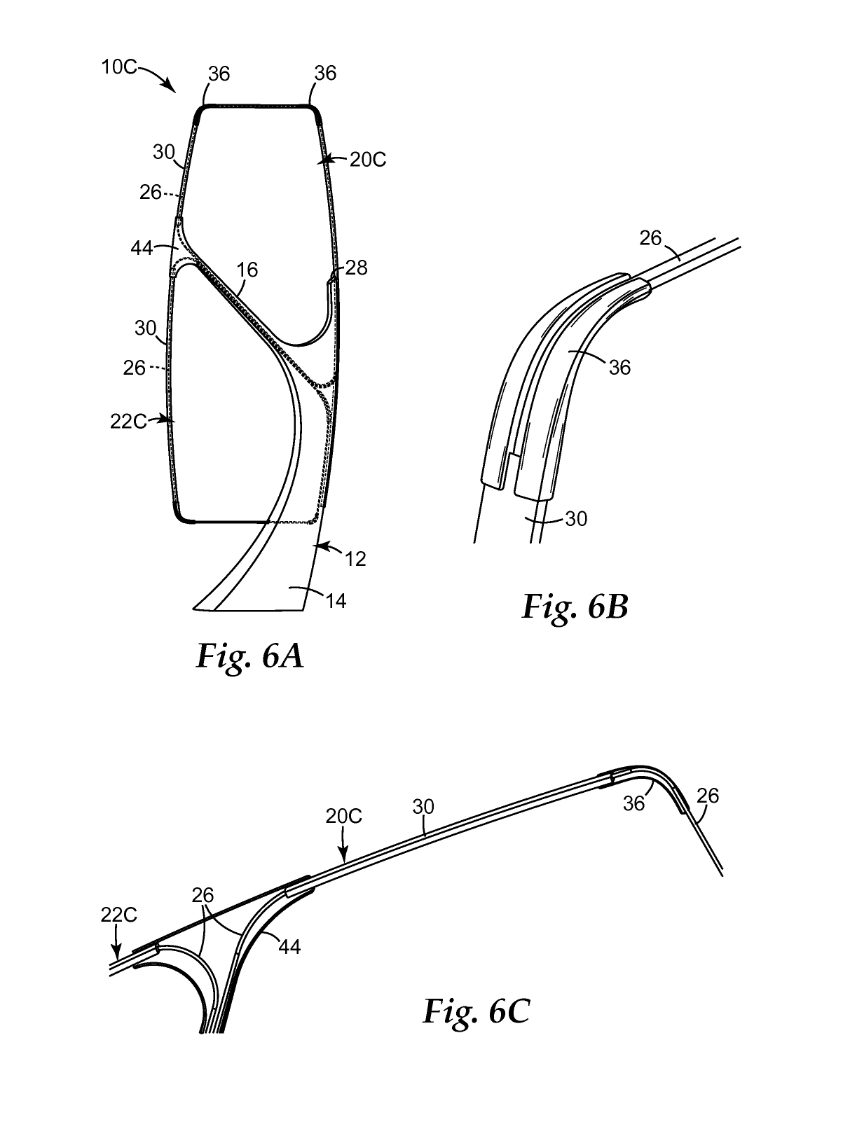

FIGS. 6A-6C illustrates a third exemplary embodiment of the gate detection system 10C of the present invention. In this embodiment, the support structure 12 of the gate detection system 10B is preferably the same support structure 12 of the gate detection system 10A of FIG. 2 and may be either an EAS or an RFID gate detection system, except that the slot 28 is configured for receiving the flexible tubes 30 of the antenna portions 20C, 22C without the use of a flange and that the antenna portions include support members. The antenna portions 20C, 22C include support members 36, which help support and shape the antenna 26. The shaping support members 36 may be any configuration or shape. The antenna wire 26 may be either exposed or covered within the shaping members 36. The shaping members help construct an antenna portion 20 having a desired shape and generating a desired field. Preferably, the antennas 20A, 20B would have a similar shape. In the illustrated embodiment, the support members 36 are used to create an approximately trapezoidal shaped antenna 26. The antenna portions 20, 22 may also include an optional flexible tube 30, which helps provide additional support to the antenna 26. The first arm 16 includes an enclosure 44 at its distal end for receiving the antennas 26 of the first antenna portion 20C and second antenna portion 22C. The shaping support members 36 and flexible tubing 30 are similar to mast elements that assist in stiffening sails in a sailboat, such as a batten or slat. The antenna wire 26 is stretched between the shaping support members 36, through flexible tubing 30, and through enclosure 44, placing the entire antenna 26 under tension, yet providing an antenna portion 20, 22 that is flexible, lightweight, and flexible and configured into a desired shape to generate a desired radio frequency field for detection of items.

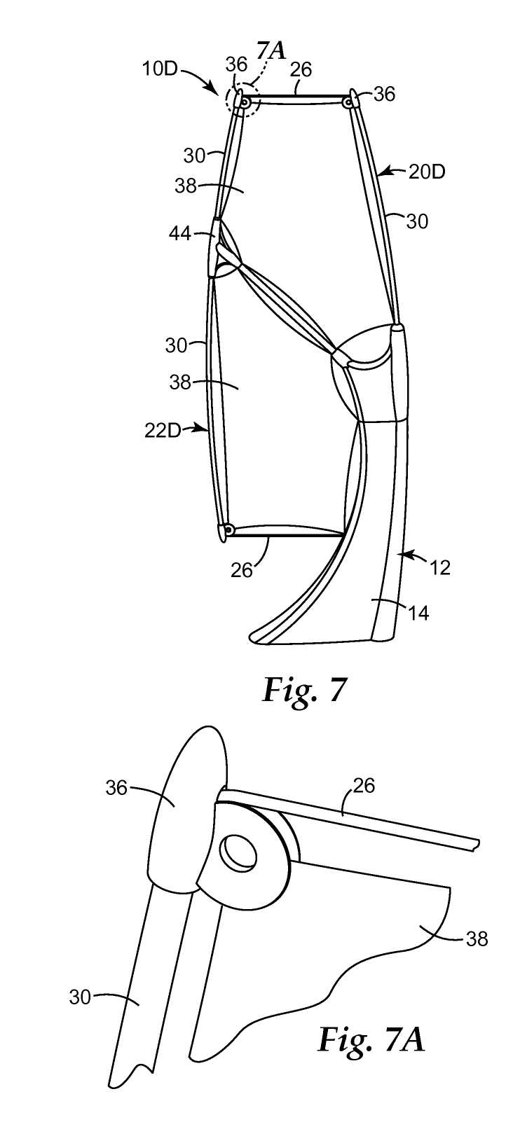

FIGS. 7 and 7A illustrate a fourth exemplary embodiment of the gate detection system 10D of the present invention. In this embodiment, the support structure 12 of the gate detection system 10D is preferably the same support structure 12 of the gate detection system 10C of FIG. 6A and may be either an EAS or an RFID gate detection system, except that the antenna portions 20D, 22D include a fabric portion 38 strung between the support members 36. The support members 36 may be decorative. The fabric portion 38 may include various pictures or words, depending on the nature of the gate detection system and the environment it is placed in. The fabric portion 38 and support members 36 provide a more decorative appearance. The fabric portion 38 maybe made of fabric or other materials, such as plastic or non-structural films. The fabric portion 38 may be mechanically attached to connectors on the support members 36 and to the first support arm 16. The antenna 26 is positioned between the support members 36 and the plastic tubing 30, similar to the gate detection system 10C in FIG. 6A.

FIG. 7A illustrates a magnified view of the ornamental shaping support member 36 of the gate detection system 10D. Various ornamental designs may be used for the shaping support member 36. The ability to choose from various decorative support members 36 and fabric portions 38 provides the ability to a customize the appearance of the gate 10D. The support structure 12 may be configured to receive the antenna portions 20A, 22A illustrated in FIG. 2, the antenna portions 20B, 22B illustrated in FIG. 4, the antenna portions 20C, 22C illustrated in FIG. 6A, or the antenna portions 20D, 20D illustrated in FIG. 7, depending on what design is desired.

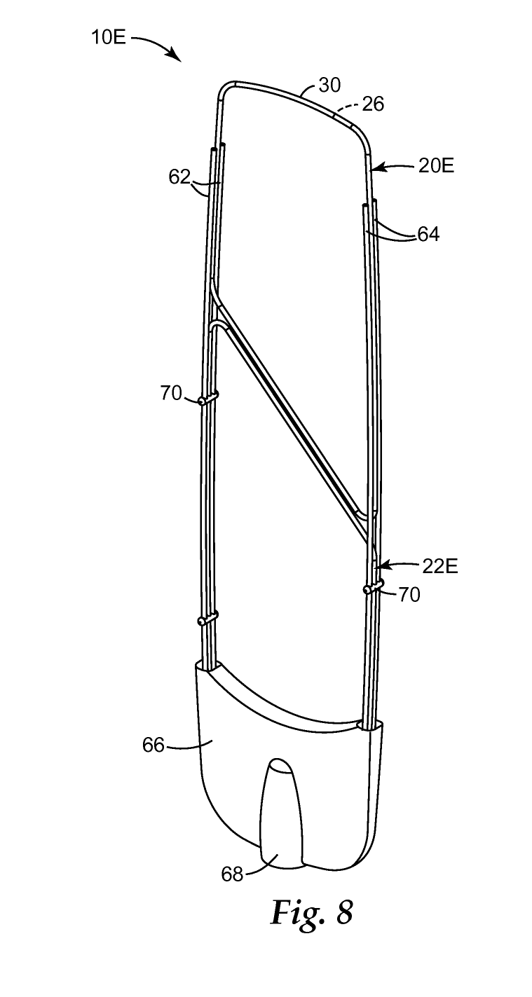

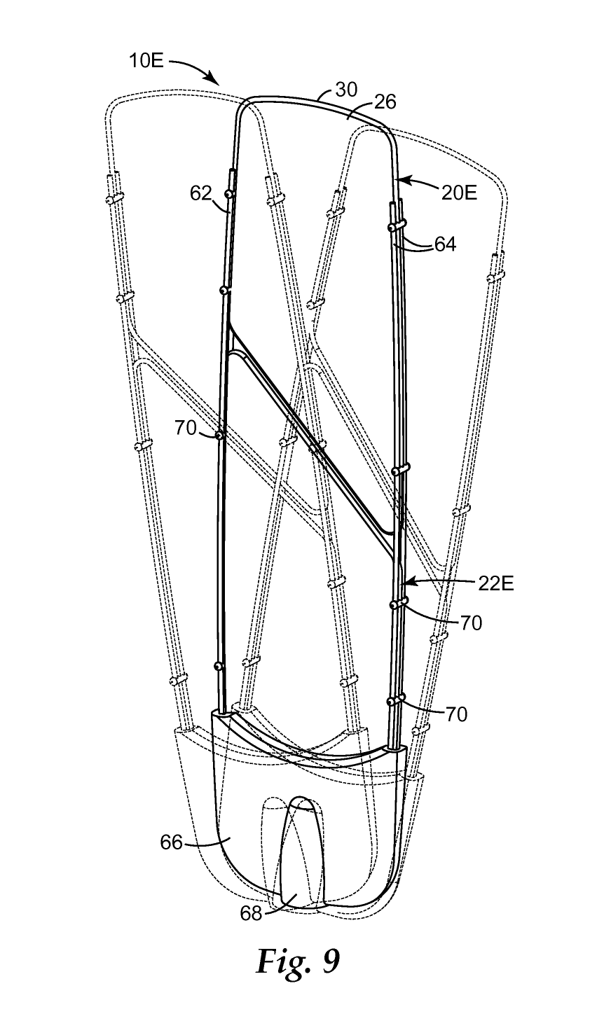

FIGS. 8 and 9 illustrate a fifth exemplary embodiment of the gate detection system 10E of the present invention. The gate detection system of FIG. 8 includes a base 66, a first support arm 62 and a second support arm 64, and two antenna loops 20E, 22E suspended between the support arms 62, 64. The support arms are preferably vertical, secured to the base 66, and configured so as to remain flexible. Spacer clips 70 preferably suspend the antenna loops between the adjacent support arms 62, 64. Preferably the spacer clips are made of nylon, or another non-ferrous, durable and low cost material. Alternatively, the antenna loops may be held in place by other suitable means known in the art. The antenna loops may include a flexible tube 30 with an antenna wire 26 inside the tube 30.

In this embodiment, the gate detection system 10E includes a base having a spring 68 to support and secure the base 66 to the floor. The spring-loaded support structure absorbs impact by bending as indicated in FIG. 9. While a rigid structure may break when subjected to repeated impact, the spring 66 allows the entire gate detection system 10E to oscillate as necessary to dampen impact. Thus, the spring-loaded support structure facilitates a lightweight structure while maintaining durability. A gate detection system 10E having a spring-loaded base tends to act similar to a ski gate, where if it is bumped into, it flexes on impact, and then snaps back in place. In addition, the visible deformation of the support structure deters further rough treatment, such as by a child attempting to climb on the gate detection system.

A spring-loaded base may be used with any of the detection systems 10 described above, and the base 66 may include any configuration consistent with the use of a spring.

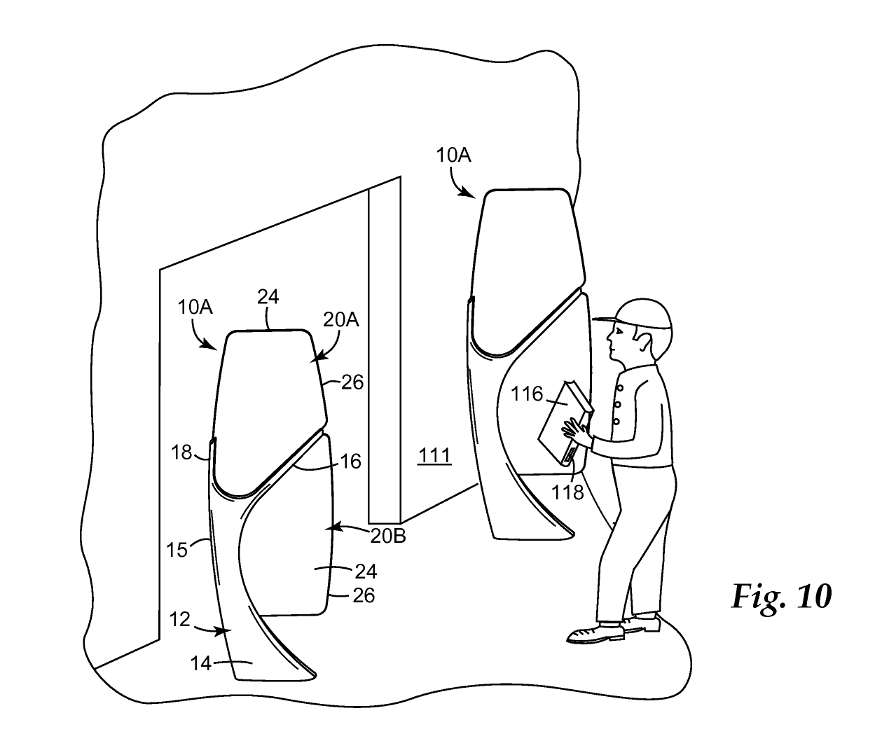

FIG. 10 illustrates the gate detection system 10A in a library setting. The gates 10A are positioned adjacent an exit 112 of a secured facility. While such an installation may include a single gate 10A, most often such an installation will include a second lattice 10A, which is positioned parallel to and spaced apart from the first gate 10A, so as to define an interrogation zone 111 there between. In such a typical use, an object 116 to which a marker 118 is attached is carried by a customer, patron, etc. through an interrogation zone. The object 116 will be detected while in interrogation zone, as follows. The marker 118 will interact with the radio frequency field generated by the antennas within the gates 10A. This will in turn cause a signal to be detected by the signal detector and trigger an alarm indicator. One suitable alarm may be provided by a flashing light or alarm mounted in within the gates 10A.

The gate detection system 10 of the present invention provides an understated, modern, and contemporary, look to detection gate systems. Its inventive design also substantially reduces the overall weight of the gate to less than 50 pounds (22.68 kg.). Lastly, the antenna portions are flexible, and easily removable, making the gates easier to ship and at a substantially reduced cost.

The present invention has now been described with reference to several embodiments thereof. The foregoing detailed description and examples have been given for clarity of understanding only. No unnecessary limitations are to be understood therefrom. All patents and patent applications cited herein are hereby incorporated by reference. It will be apparent to those skilled in the art that many changes can be made in the embodiments described without departing from the scope of the invention. Thus, the scope of the present invention should not be limited to the exact details and structures described herein, but rather by the structures described by the language of the claims, and the equivalents of those structures.

What is claimed is:

1. A detection system, comprising:
a support structure, comprising a base and a support arm attached to the base; and
a first antenna portion removably engaged with the support arm, wherein the first antenna portion is configured to form a radio frequency field for detecting items within the field, and
wherein the support structure is rigid, and the antenna portion is flexible relative to the support structure.

2. The detection system of claim 1, wherein the support structure is asymmetrical relative to the vertical plane of the support structure.

3. The detection system of claim 1, wherein the antenna portion is light-weight relative to the support structure.

4. The detection system of claim 1 further comprising a second antenna portion removably engaged with the support arm.

5. The detection system of claim 1, wherein the detection system is an electronic article surveillance detection system.

6. The detection system of claim 1, wherein the detection system is a radio-frequency identification detection system.

7. The detection system of claim 1, wherein the first antenna portion includes a flexible tube and an antenna wire inside the flexible tube.

8. The detection system of claim 7, wherein the first antenna portion includes an opening inside the antenna portion.

9. The detection system of claim 1, wherein the first antenna loop portion includes an antenna wire wrapped around a panel portion.

10. The detection system of claim 1, wherein the first antenna loop portion includes shaping support members and an antenna wire wrapped under tension around the shaping support members.

11. A detection system, comprising:
a support structure, comprising an base and a support arm attached to the base; and
a first antenna portion removably engaged with the support arm, wherein the first antenna portion is configured to form a radio frequency field for detecting items within the field, and wherein the first antenna loop portion includes shaping support members and an antenna wire wrapped under tension around the shaping support members.

12. The detection system of claim 11, wherein the support structure is asymmetrical relative to the vertical plane of the support structure.

13. The detection system of claim 11, wherein the antenna portion is light-weight relative to the support structure.

14. The detection system of claim 11 further comprising a second antenna portion removably engaged with the support arm.

15. The detection system of claim 11, wherein the detection system is an electronic article surveillance detection system.

16. The detection system of claim 11, wherein the detection system is a radio-frequency identification detection system.

17. The detection system of claim 11, wherein the first antenna portion includes an opening inside the antenna portion.

18. A detection system, comprising:
a support structure, comprising a base and a support arm attached to the base; and
a first antenna portion removably engaged with the support arm, wherein the first antenna portion is configured to form a radio frequency field for detecting items within the field, and wherein the first antenna loop portion includes a fabric portion and an antenna wire stretched around the fabric portion.

19. The detection system of claim 18, wherein the support structure is asymmetrical relative to the vertical plane of the support structure.

20. The detection system of claim 18, wherein the antenna portion is light-weight relative to the support structure.

21. The detection system of claim 18 further comprising a second antenna portion removably engaged with the support arm.

22. The detection system of claim 18, wherein the detection system is an electronic article surveillance detection system.

23. The detection system of claim 18, wherein the detection system is a radio-frequency identification detection system.

24. A detection system, comprising:
a spring-loaded support structure, comprising a base, at least one support arm attached to the base, and a spring for supporting the base wherein the support structure may oscillate back and forth on the spring; and
a first antenna loop portion attached to the support arm, wherein the first antenna portion is configured to form a radio frequency field for detecting items within the field.

25. The detection system of claim 24 further comprising a second antenna portion attached to the support arm.

26. The detection system of claim 24, wherein the detection system is an electronic article surveillance detection system.

27. The detection system of claim 24, wherein the detection system is a radio-frequency identification detection system.

28. The detection system of claim 24, wherein the first antenna portion includes a flexible tube and an antenna wire inside the flexible tube.

29. The detection system of claim 24, wherein the first antenna portion includes an opening inside the antenna portion.

30. A detection system, comprising:
a support structure, comprising a base, and at least two vertical support arms extending from the base; and
a first antenna loop stretched between the two support arms, wherein the first antenna portion is configured to form a radio frequency field for detecting items within the field.

31. The detection system of claim 30 further comprising a second antenna loop stretched between the two support arms.

32. The detection system of claim 30, wherein the detection system is an electronic article surveillance detection system,

33. The detection system of claim 30, wherein the detection system is a radio-frequency identification detection system.

34. The detection system of claim 30, wherein the first antenna portion includes a flexible tube and an antenna wire inside the flexible tube.

35. The detection system of claim 30, wherein the first antenna portion includes an opening inside the antenna portion.
